(19) United States
(12) Patent Application Publication
(10) Pub. No.: US 2012/0011450 A1
(43) Pub. Date: Jan. 12, 2012

(54) METHODS AND SYSTEMS FOR GENERATING AND SHARING AN INTERACTIVE VIRTUAL MEETING SPACE

(76) Inventor: Paul To, Menlo Park, CA (US)

(21) Appl. No.: 13/177,176

(22) Filed: Jul. 6, 2011

Related U.S. Application Data
(60) Provisional application No. 61/361,919, filed on Jul. 7, 2010.

(51) Int. Cl. G06F 3/00

(52) U.S. Cl. 715/752

(57) ABSTRACT

Embodiments of the invention provide a computer-implemented methods and systems for interactive communication in a network. The method includes creating, by a first user of a first device, an electronic greeting card comprising at least one interactive object. The electronic greeting card provides a virtual meeting space for a plurality of users. Further, the method includes sending, by the first user, the electronic greeting card to one or more of the plurality of users. The one or more of the plurality of users modify the electronic greeting card. The method further includes sending, by the first user, the modified electronic greeting card to a receiver of the plurality of users. Furthermore, the method includes displaying, at a receiving device of the receiver, the modified electronic greeting card. The plurality of the first users and the receiver can interactively communicate through the virtual meeting space.

### CROSS REFERNCE TO RELATED APPLICATIONS

This application is a Non-Provisional application of U.S. Provisional application Ser. No. 61/361,919 entitled ‘Systems and methods for creating, sharing and interacting with persistent social space’ and filed on Jul. 7, 2010, which is incorporated herein by reference in its entirety.

### BACKGROUND OF THE INVENTION

Various types of greeting cards are usually sent or received on special occasions, such as birthdays, anniversaries, Christmas or other holidays. Further, greeting cards are also sent to convey feelings such as thanks, love, sympathy and so forth. Generally, greeting cards are printed on papers such as card-stock. Further, the greeting cards may be in form of photo greeting card or musical greeting cards.

With the increasing popularity and penetration of electronic technology and computer networks, electronic greeting cards have also gained importance. Electronic greeting cards (also called E-cards) can also be sent electronically. For example, flash-based cards can be sent by e-mail. Further, various websites such as Facebook, Hallmark, and so forth enable a user to send greeting card. Moreover, the first user can select a greeting card, customize it, and send it to one or more recipients. However, this process or greeting card is merely a one-time event and the first user's experience comes to an end after the recipient opens the card and reads or listens to it. Therefore, the recipient may forget the greeting card and the experience as time passes.

In light of the above discussion, techniques are desirable for creating electronic cards which provide senders and receivers with an ongoing interaction experience, essentially providing a persistent social space, or a virtual meeting space for senders and receivers to share content, social expressions and carry on with various kinds of social interactions.

### SUMMARY

Embodiments of the present invention provide a method for generating an interactive virtual meeting space in a network. Embodiments of the invention provide a computer-implemented methods and systems for interactive communication in a network. The method includes creating, by a first user of a first device, an electronic greeting card comprising at least one interactive object. The electronic greeting card provides a virtual meeting space for a plurality of users. Further, the method includes sending, by the first user, the electronic greeting card to one or more of the plurality of users. The one or more of the plurality of users modify the electronic greeting card. The method further includes sending, by the first user, the modified electronic greeting card to a receiver of the plurality of users. Furthermore, the method includes displaying, at a receiving device of the receiver, the modified electronic greeting card. The plurality of the first users and the receiver can interactively communicate through the virtual meeting space.

Embodiments of the invention also provide a computer-implemented system for interactive communication in a network. The system includes a first device associated with a first user. The first device includes a first interface creator configured to enable the first user to create an electronic greeting card comprising at least one interactive object. The electronic greeting card provides a virtual meeting space for a plurality of users. The first device also includes a first transceiver configured to enable the first user to send the electronic greeting card to one or more of the plurality of users and a receiver, wherein the one or more of the plurality of users modify the electronic greeting card and to send the modified electronic greeting card to at least one receiver. The system further includes a receiving device associated with the receiver. The receiving device includes a display configured to display the modified greeting card and a second interactor configured to enable the receiver to interactively communicate with the plurality of the first users through the virtual meeting space.

The present invention further provides an interactive virtual meeting space generator in a network. The interactive virtual meeting generator includes an interface creator configured to enable the first user to create an electronic greeting card comprising at least one interactive object, wherein the electronic greeting card provides a virtual meeting space for a plurality of users. The interactive virtual meeting space generator includes a transceiver configured to enable the first user to send the electronic greeting card to one or more of the plurality of users and a receiver, wherein the one or more of the plurality of users modify the electronic greeting card and to send the modified electronic greeting card to at least one receiver. The modified electronic greeting card is displayed at a receiving device of the receiver. Further, the interactive virtual meeting space generator includes an interactor configured to enable the configured to enable the receiver to interactively communicate with the plurality of the first users through the virtual meeting space.

An aspect of the invention is to enable creation of an interactive virtual meeting space by one or more users.

An aspect of the invention is to create an interactive virtual meeting space by collaborations or one or more collaborators.

Another aspect of the invention is to enable sharing of the electronic greeting card or interactive virtual meeting space with the one or more users. In an embodiment of the invention, the one or more users may be friends, acquaintances, relatives, public groups, and so forth.

Still another aspect of the invention is to enable interaction of the users with the virtual meeting space.

The virtual meeting space may include online shared space, where various users can interact with each other.

An aspect of the invention is to use the greeting card motif or metaphor of creating, sending, and receiving greeting cards as method to allow creation of the virtual meeting place, to invite other people to join and collaborate or interact in the meeting place.

### BRIEF DESCRIPTION OF THE DRAWINGS

Having thus described the invention in general terms, reference will now be made to the accompanying drawings, which are not necessarily drawn to scale, and wherein:

FIG. 1 illustrates an exemplary environment where various embodiments of the present invention function;

FIG. 2 is a block diagram illustrating various system elements of the environment, in accordance with an embodiment of the invention;

FIG. 3 illustrates block diagram of an interactive virtual meeting space generator in a network, in accordance with an embodiment of the invention;

FIG. 4 illustrates an exemplary stages in life cycle of an electronic greeting card;

FIG. 5A illustrates exemplary process for creating the electronic greeting card;

FIG. 5B illustrates exemplary process for sending the electronic greeting card to one or more of plurality of users for collaboration;

FIG. 6 illustrates exemplary process for collaborating on an exemplary electronic greeting card, in accordance with an embodiment of the invention;

FIG. 7 illustrates exemplary process for receiving the electronic greeting card, in accordance with an embodiment of the invention;

FIG. 8 illustrates an exemplary electronic greeting card, in accordance with an embodiment of the invention;

FIG. 9 illustrates an exemplary flowchart for creating an electronic greeting card; and

FIGS. 10A and 10B illustrates an exemplary flowchart for generating, sharing and interacting with the electronic greeting card, in accordance with an embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

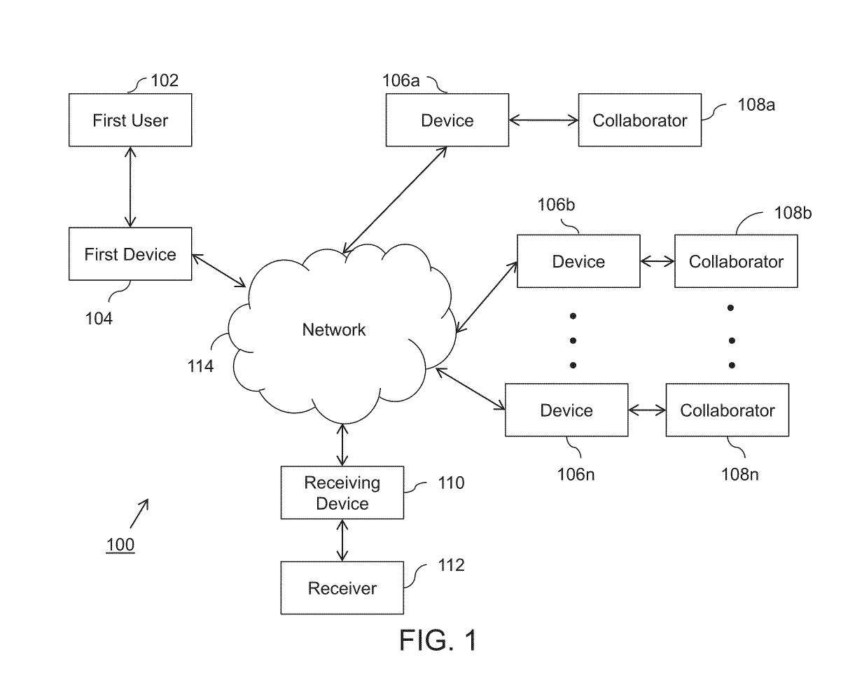

With reference to FIG. 1 an exemplary environment 100 is shown where various embodiments of the present invention function. A first user 102 may use a first device 104 to create an electronic greeting card in a network 114 for a receiver 112. The electronic greeting card may include at least one interactive object. The electronic greeting card provides a virtual meeting space to a plurality of users for interacting with each other. Examples of the at least one interactive object include, but are not limited to, an image, a text message, a social networking website status message, a social networking website mail, a social networking website profile page, a Short Messaging Service (SMS) message, a Multimedia Messaging Service (MMS) message, an instant message, an audio file, a video file, and so forth. The electronic greeting card may include messages, graphics, audios, videos and/or various other options/modes for interaction. First device 104 is configured to enable first user 102 to create one or more messages comprising the electronic greeting card to share the virtual meeting space with other users such as receiver 112 or one or more of the plurality of users such as one or more collaborators 108a-n. In an embodiment of the invention, first user 102 can create customized message including the electronic greeting card or information about the electronic greeting card. Hereinafter, one or more collaborators 108a-n will refer to one or more of plurality of users and may be used interchangeably. Further, first device 104 is configured to send the customized message to one or more collaborators 108a-n for collaboration to the electronic greeting card. In an embodiment of the invention, first user 102 may send the electronic greeting card to share the virtual meeting space with a plurality of users in network 114. In an embodiment of the invention, first user 102 may invite one or more collaborators 108a-n to sign in to the electronic greeting card. In an embodiment of the invention, the first user 108 may distribute the responsibilities of setting up the virtual meeting space among other users such as one or more collaborators 108a-n by allowing them to sign in to the electronic greeting card. Therefore, the burden of setting up and maintaining the virtual meeting space or electronic greeting card is distributed among various users.

In an embodiment of the invention, one or more collaborators 108a-n can modify the electronic greeting card. In an embodiment of the invention, first device 104 is configured to receive the modified electronic greeting card from one or more collaborators 108a-n with one or more modifications or additions. First device 104 is also configured to share the modified electronic greeting card with receiver such as receiver 112. In an embodiment of the invention, first device 104 is also configured to create one or more message(s) including the electronic greeting card or information about the electronic greeting card to share the virtual meeting space with receiver 112 by sending the electronic greeting card. Examples of the information about the electronic greeting card include, but are not limited to, an image, a Uniform Resource Locator (URL), an audio file, a video file, a description about the electronic greeting card, and so forth.

Receiver 112 of the plurality of users can view and/or interact with the electronic greeting card at a receiving device 110. The electronic greeting card may be displayed at receiving device 110. Receiving device 110 is configured to enable receiver 112 to interact with the virtual meeting space by selecting and/or manipulating at least one interactive object. Further, receiving device 110 doesn't require any hardware and/or software setup for accessing the virtual meeting space. Further, receiver 112 need not to do any set up such as registering to a website, creating a meeting place, creating a personal profile, creating a chat room, creating a social space, and so forth for interacting through the virtual meeting space. Further, the plurality of the users and the first user can interactively communicate through the virtual meeting space.

In an embodiment of the invention, receiver 112 may add one or more interactive objects in the electronic greeting card. Furthermore, receiver 112 may receive the one or more messages from first user 102. Receiver 112 can access these messages at receiving device 110. Receiver 112 can manipulate the at least one interactive object of the electronic greeting card and can interact with other users such as first user 102 accordingly. In another embodiment of the invention, receiver 112 may enter or access the electronic greeting card just by clicking or selecting a link in the received message. Receiver 112 may not require entering login details such as, but not limited to, name, password, etc. Further, receiver 112 may reply to first user 102 or one or more collaborators 108a-n by selecting and/or manipulating at least one interactive object of the electronic greeting card. For example, a receiver 112 such as a grandmother can receive an electronic greeting card including messages from one or more relatives or friends, and after opening the card she can enter the virtual meeting space. Thereafter, she can interact or reply to sender or relatives by selecting at least one interactive option such as an image from the electronic greeting card. The virtual meeting space provides an environment to the grandmother to interact with the sender of the electronic card and other users who have contributed in the greeting card.

According to an embodiment of the invention, the electronic greeting card may remain interactive even after it has been opened or viewed. Therefore, the disclosed electronic greeting card may be termed as a living greeting card. As the electronic greeting card remains alive in the sense that receiver 112 of the card can interact with the sender(s) of the greeting card even after opening the card. In an embodiment of the invention, receiver 112 may invite one or more users to interact in the virtual meeting space by sending an invitation message or by directly adding them into the virtual meeting space.

Further, first user 102 may send the electronic greeting card to one or more of the plurality of users such as one or more collaborators 108a-n associated with devices 106a-n to collaborate in creating or enhancing the virtual meeting space. Herein after, one or more collaborators 108a-n will refer to one or more of the plurality of users without changing its meaning. For example, one or more collaborators 108a-n can be family members, friends, relatives, and so forth. Further, one or more collaborators 108a-n are associated with one or more devices 106a-n. One or more collaborators 108a-n may receive the message from first device 104 and can view the shared electronic greeting card at one or more devices 106a-n. Further, one or more collaborators 108a-n can change or add one or more interactive objects to the electronic greeting card. One or more collaborators 108a-n may enhance the electronic greeting card by entering in the virtual meeting space by clicking or selecting the link in the message.

As shown, first user 102 may communicate with receiver 112 over network 114. However a person skilled in the art will appreciate that first user 102, receiver 112 and one or more collaborators 108a-n may be connected directly to each other. Examples of first device 104, receiving device 110, and one or more devices 106a-n include, but are not limited to, a computer, a laptop, a mobile phone, a smart-phone, a display, a tablet computer, an electronic picture frame, an internet connected television, or other electronic devices capable of presenting a multimedia experience. Further, first device 104, receiving device 110, and one or more devices 106a-n may include a touch sensitive screen or device to interact with them. Moreover, first device 104, receiving device 110, and one or more devices 106a-n may include one or more processors, memory, input/output interfaces, network interfaces, operating systems, web browsers and/or other hardware, software and/or firmware.

Examples of network 114 include, but are not limited to, a Local Area Network (LAN), a Wireless Local Area Network (WLAN), a Wide Area Network (WAN), the Internet, the Bluetooth, the Wi-Fi network, a mobile network and so forth. The system for generating, sharing and/or interacting with the virtual meeting space may be available at a device such as a server (not shown) in network 114 or first device 104, receiving device 110, one or more devices 106a-n. Examples of the server may include, but are not limited to, a computer, a laptop, a mobile phone, a smart phone and or other electronic devices capable of storing, processing and communicating data. Further, the server may include one or more processors, memory, input/output interfaces, network interfaces, operating systems, web browsers and/or other hardware, software and/or firmware. A person skilled in the art will appreciate that other forms of hardware, software and/or firmware may be used for the system. Moreover, the system may include various instructions stored in a memory and executable by a processor to perform various processes.

Therefore, first user 102, receiver 112 and one or more collaborators 108a-n can interact with each other by using the virtual meeting space. Hereinafter, the virtual meeting space may refer to an interactive virtual meeting space and may be used interchangeably without changing its meaning. The electronic greeting card is a persistent interactive virtual meeting space (or social space) where people can interact with each other in real time or asynchronously adding objects, message, post comments, etc. In an embodiment of the invention, any user can create a new instance of the electronic greeting card. For example, first user 102 can create new online or electronic greeting card. First user 102 can select a theme, different interactive objects, and various images to create the greeting card. For example, the theme can be a home theme including images and background related to home, a jungle theme will include background and images related to jungle trees, a garden theme, a city theme, an office theme, a horror theme, and so forth. The electronic greeting card may provide a visual summary of the theme and content of the electronic greeting card. It may also be represented as a thumbnail image which can contain static or live updates of content and activities that are happening within the social space. When a user such as receiver 112 or collaborators 108a-n opens the online or electronic greeting card, he/she enters the virtual meeting space. Thereafter, the first user may add or remove one or more interactive object or may also interact with other users. First user 102 can share content such as text message, photos, audio/video records, web links, etc with other users i.e. receiver 112 or one or more collaborators 108a-n. These content are represented as interactive objects that are placed within the virtual meeting space for other users to see and interact with. According to an embodiment of the invention, the online or electronic greeting card is an electronic greeting card that provides an ongoing social interaction experience, even after the electronic greeting card had been sent, accepted, and opened or expired.

Further, the electronic greeting card or the virtual meeting space may remain active till a predefined condition is fulfilled and may expire after the predefined condition has been fulfilled. The predefined condition may be based on time, purpose, or goal associated with an event. But the virtual meeting space or the electronic greeting card will be available for viewing by the first users even after it has expired.

Further, the plurality of users can apply one or more play control functions such as, but not limited to, replay, play, rewind, fast-forward, pause, stop, record, print, and so forth to the electronic greeting card even after the predefined condition has been fulfilled. For example, a user of the plurality of users can replay the interactions made in the past, the user can fast forward or rewind the interactions. Further, the user may record the interactions on a DVD, CD etc to view through another device such as Television, DVD player, etc. Further, the user may print the electronic greeting card. In an embodiment of the invention, the plurality of users may select a printing theme such as a comic, a book, etc. for printing the electronic greeting card.

In another embodiment of the invention, the virtual meeting space or the online or electronic greeting card can have various life spans. Some electronic greeting cards can provide a virtual meeting space to various users that may live on indefinitely. Yet, some greeting cards may have a specific purpose and the electronic greeting card will be closed once that purpose has been achieved. For example, a Thanksgiving Holiday greeting card may provide a virtual meeting space for participants to virtually plan and virtually gather for Thanksgiving Holiday. But the Thanksgiving Holiday greeting card will be closed and may become a time capsule once thanksgiving occasion is over. Further, the electronic greeting card will be available for viewing by various users even after the occasion is over or specific purpose has been achieved. In an embodiment of the invention, the electronic greeting card may remain active till specific goal or purpose is achieved. For example, an electronic greeting card such a web page may remain active till 1000 people have visited it, or 100 people have contributed in it.

Further, while creating the electronic greeting card, the one or more collaborators may sign the greeting card of the virtual meeting space. Therefore, in this way the responsibility of setting up and maintaining the virtual meeting space can be distributed among more than one user. In an embodiment of the invention, receiver 112 may view and access the virtual meeting space without entering the login details such as, but not limited to name, password, etc. Further, receiver 112 is not required to do any setup such as, but not limited to, setting up a meeting place, setting up a social space, registering to a website, adding friends, and so forth.

In accordance with another embodiment of the invention, the electronic greeting card or the virtual meeting space may remain active till a predefined condition is fulfilled and may expire after the predefined condition has been fulfilled. The predefined condition may be based on time, purpose, or goal associated with an event. But the virtual meeting space or the electronic greeting card will be available for viewing by the first users even after it has expired. In an embodiment of the invention, the predefined condition may be set by first user 102 or one or more collaborators 108a-n. In another embodiment of the invention, the predefined condition may depend on an occurrence of an event such as but not limited to, a festival, a date, and so forth. Examples of the predefined condition include, but not limited to, 48 hours, 5 days, 3 months, Christmas, Good Friday, Thanks giving day, and so forth. In an embodiment of the invention, the electronic greeting card cannot be changed after the predefined condition is over. For example, a virtual meeting space such as an online greeting page created for Christmas can be collaborated or changed till Christmas Day only. After the Christmas is over the greeting may be accessible, but only for viewing and cannot be changed or modified by any user (i.e. receiver 112 or first user 102 or one or more collaborators 108a-n).

Further, the plurality of users can apply one or more play control functions such as, but not limited to, replay, play, rewind, fast-forward, pause, stop, record, print, and so forth to the electronic greeting card even after the predefined condition has been fulfilled. For example, a user of the plurality of users can replay the interactions made in the past, the user can fast forward or rewind the interactions. Further, the user may record the interactions on a DVD, CD etc to view through another device such as Television, DVD player, etc. Further, the user may print the electronic greeting card. In an embodiment of the invention, the plurality of users may select a printing theme such as a comic, a book, etc. for printing the electronic greeting card.

In an embodiment of the invention, when the virtual meeting space or an online or electronic greeting card reaches the end of a life span, it becomes a time capsule. After end of life span of the virtual meeting space or the greeting card, the first users or participants may not be able to post new comment or add new content in the electronic greeting card. But the electronic greeting card can be accessed or viewed at a later time even after end of the life span of the electronic greeting card. Therefore, even after the end of life span of the electronic greeting card, the participants or the first users are allowed to reminisce by browsing objects that has been shared.

In an embodiment of the invention, the environment 100 may include more than one receiver 112. Further, first user 102 can share the virtual meeting space or send the online or electronic greeting card to the more than one receiver 112.

In an embodiment of the invention, first user 102 can generate an interactive electronic greeting card. In an embodiment of the invention, the interactive electronic greeting card may be generated by using an interactive virtual meeting space generator. The interactive virtual meeting space generator may be present at first device 104, a receiving device 110, at one or more devices 106a-n, the server, and so forth. The interactive virtual meeting space generator may be configured to create an electronic greeting card and enable different users such as first user 102, collaborators 108a-n and receiver 112 to interact with each other via the virtual meeting space provided by the electronic greeting card. The virtual meeting space generator is also configured to generate one or more customized messages for sending the electronic greeting card and sharing the virtual meeting space with plurality of users in network 114. The interactive virtual meeting space generator may be present at any device in network 114. First user 102, one or more collaborators 108a-n, receiver 112 or other users can use the virtual meeting space generator to create and share an interactive virtual meeting space. In an embodiment of the invention, the virtual meeting space generator may be present in a service provider's network. In another embodiment of the invention, the electronic greeting card may be implemented in a cloud based network. The service provider may provide services for enabling user(s) to create and share the electronic greeting card and may charge for the services.

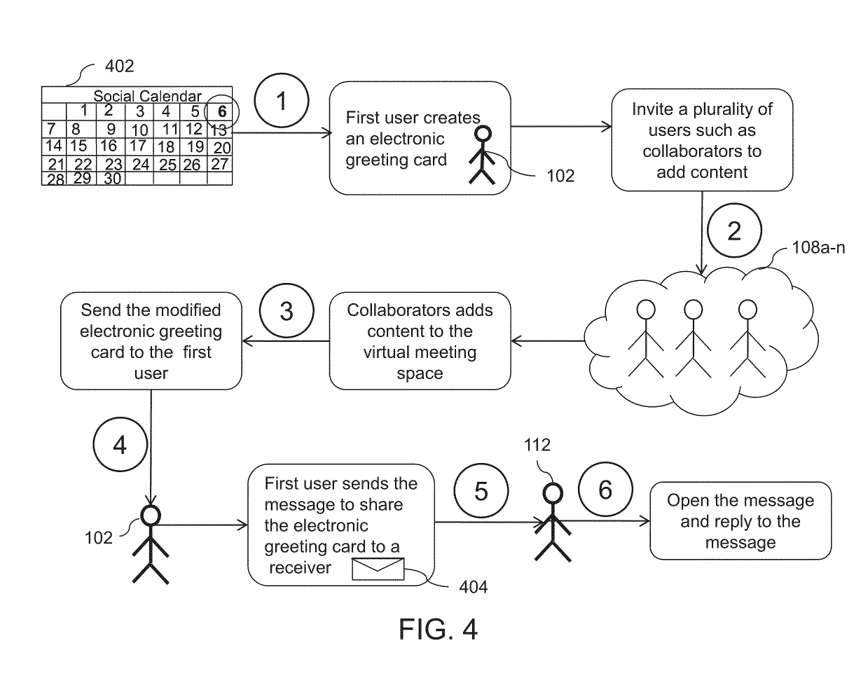

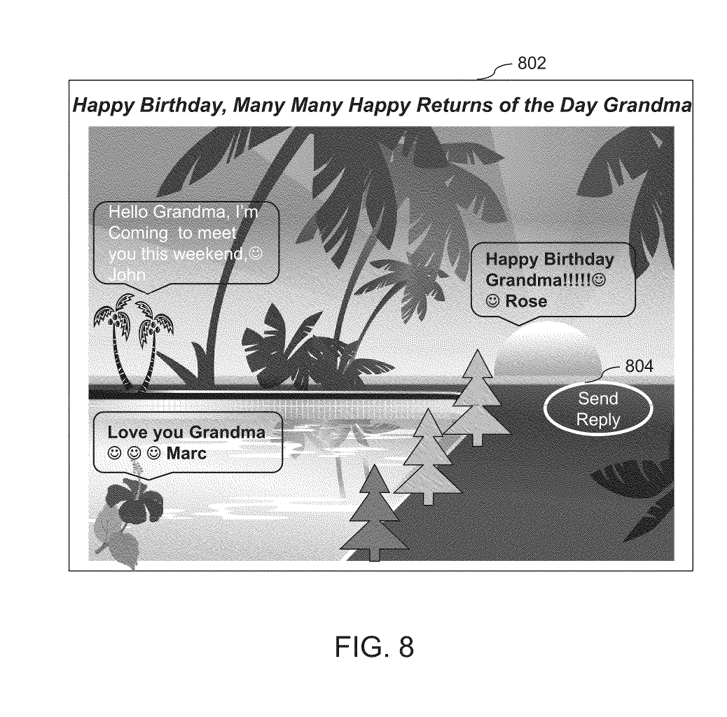

An exemplary electronic greeting card is explained in conjunction with FIG. 8, and the exemplary stages in the life cycle of the electronic greeting card are explained in conjunction with FIG. 4-7.

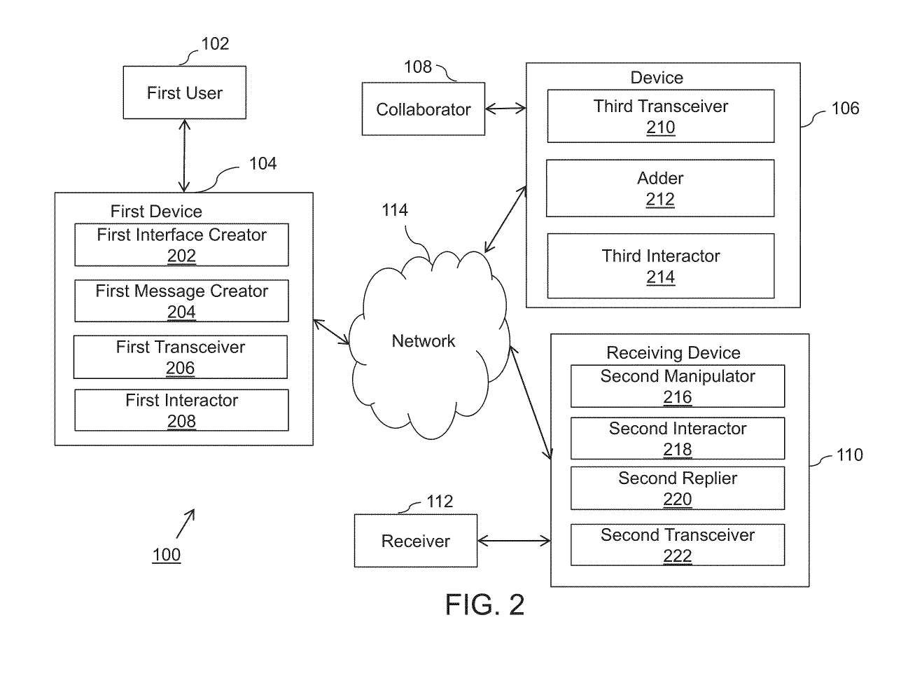

FIG. 2 is a block diagram illustrating various system elements of environment 100, in accordance with an embodiment of the invention. As discussed with reference to FIG. 1, environment 100 includes first device 104, one or more devices 108a-n, and receiving device 110 connected to each other via network 114. First device 104 includes a first interface creator 202, a first message creator 204, a first transceiver 206, and a first interactor 208. First interface creator 202 is configured to enable first user 102 to create an electronic greeting card at a server. The electronic greeting card includes at least one interactive object. Examples of the at least one interactive object include, but are not limited to, an image, a text message, a social networking website status message, a social networking website mail, a social networking website profile page, a Short Messaging Service (SMS) message, a Multimedia Messaging Service (MMS) message, an instant message, an audio file, a video file, and so forth. In an embodiment of the invention, the virtual meeting space may be in form of an electronic greeting card that includes messages, graphics, audios, videos and/or various other options/modes for interaction.

First message creator 204 is configured to enable first user 102 to create one or more messages for sending the electronic greeting card and sharing the virtual meeting space with other users in network 114. In an embodiment of the invention, first user 102 may share the virtual meeting space with other users by sending the electronic greeting card. The created electronic greeting card provides a platform for various users such as receiver 112, collaborators 108a-n, first user 102 to interact through the virtual meeting space. Further, first user 102 can also create other messages such as text message, MMS by using first message creator 204. First transceiver 206 is configured to enable sharing of the electronic greeting card with receiver 112 and one or more collaborators. First transceiver 206 is configured to send the one or more messages to receiver 112 and/or one or more collaborators 108a-n. The one or more messages may include information necessary for sharing the electronic greeting card with other users. In an embodiment of the invention, the one or more messages may include a customized message for the intended receiver (or collaborators 108a-n). One or more collaborators 108a-n may add or sign into the virtual meeting space. This way the responsibility of setting up and maintaining the virtual meeting space gets distributed among more than one user. In an embodiment of the invention, first transceiver 206 may be configured to receive reply from receiver 112. Receiver 112 is allowed to interact with other users by adding one or more interactive object into the electronic greeting card. First receiver 206 is further configured to receive multiple messages from one or more collaborators 108a-n or receiver 112. First interactor 208 enables first user 102 to interact with other users such as receiver 112, one or more collaborators 108a-n, and so forth. In an embodiment of the invention, first user 102 can interact with other users in real-time or asynchronously. Though not shown, a person skilled in art will appreciate that first device 104 may also include a first memory configured to store programs. The first memory may include an Operating System (OS) for first device 104 to function properly. Further, the first memory may include other applications that enables first user 102 to share virtual meeting space with other users. Examples of other applications include, but are not limited to, Skype, Google Talk, Magic Jack, Nimbuzz, and so forth. Other applications may be stored as software or firmware on first device 104.

Receiving device 110 may include a second manipulator 216, a second interactor 218, a second replier 220, and a second transceiver 222. Receiver 112 can interact with the virtual meeting space by manipulating the at least one interactive object of the electronic greeting card (shared by first user 102). In an embodiment of the invention, receiver 112 may add an interactive object to the electronic greeting card. In an embodiment of the invention, the electronic greeting card may be created by using an application running in a cloud based network. Second manipulator 216 is configured to enable manipulation of the at least one interactive object by the receiver such as receiver 112. Second interactor 218 is configured to enable interaction of receiver 112 with the electronic greeting card based on manipulations by receiver 112. Further, second replier 220 is configured to enable the receiver to reply by manipulating the at least one interactive object. The reply can be such as, but not limited to, a text message, an SMS message, an MMS message, an audio file, a video file, and so forth. Further, second transceiver 222 is configured to receive the one or more messages from first user 102 and/or one or more collaborators 108a-n at first device 104. The one or messages may include the information for sharing the electronic greeting card such as a text message, a URL, and so forth. Receiver 112 can select the at least one interactive object from the electronic greeting card and may get reply message(s) from other users (such as first user 102 or one or more collaborators 108a-n) accordingly. In an embodiment of the invention, the reply or reply messages from the other users may be received in real-time. Though not shown, receiving device 110 may include a second memory configured to store programs. The second memory may include an Operating System (OS) for receiving device 110 to function properly. Further, the second memory may include other applications that enable receiver 112 to interact and select one or more interactive objects from the electronic greeting card. Examples of other applications include, but are not limited to, Skype, Google Talk, Magic Jack, Nimbuzz, and so forth. Other applications may be stored as software or firmware on receiving device 110.

Each device 106 of one or more devices 106a-n may include a third transceiver 210 configured to receive at least one message(s) from other users such as first user 102, receiver 112, and so forth in network 114. Third transceiver 210 is further configured to send or share mails and messages with other users i.e. first user 102, receiver 112. Device 106 further includes an adder 212 configured to enable one or more collaborators 108a-n to add one or more interactive objects to the electronic greeting card shared by first user 102 (or other users). For example, collaborators 108a-n may add an image, a message, an MMS message, an SMS message, and so forth in the virtual meeting space. In an embodiment of the invention, one or more collaborators 108a-n can create a new electronic greeting card and can embed the new electronic greeting card in the shared virtual meeting space. In an embodiment of the invention, the at least one interactive object or the one or more objects keep on floating in the electronic greeting card. For example, an electronic greeting card may include stars which may move from one place to another on the displayed greeting card. Third interactor 214 enables one or more collaborators 108a-n to interact with first user 102, receiver 112, and so forth. Though not shown, receiving device 110 may include a third memory configured to store programs and operating system. Examples of the first, second and third memory includes, but not limited to, a Random Access Memory (RAM), a Read Only Memory (ROM), a hard disk, and so forth. A person skilled in the art will appreciate that other types of computer-readable media which can store data that is accessible by a computer, such as magnetic cassettes, flash memory cards, digital video disks, and the like, may also be used by devices such as first device 104, one or more device 106a-n, receiving device 110, and so forth. The third memory may include an Operating System (OS) (not shown) for device 106 to function. Further, the third memory of device 106 may include other applications that enable collaborator 108 to share electronic greeting card with other users. Examples of other applications include, but are not limited to, Skype, Google Talk, Magic Jack, Nimbuzz, and so forth. Other applications may be stored as software or firmware on device 106. Though not shown in FIG. 2, environment 100 may include more than one device 106 and more than one collaborator 108.

Further, receiving device 110 may not require any special hardware or software for viewing the electronic greeting card. Further, receiver 112 may not have to enter his/her login details or register to a website for viewing the electronic greeting card. Receiver 112 can simply view the electronic greeting card by selecting or clicking the link provided in the message(s) received for sharing the virtual meeting space. After viewing and entering into the virtual meeting space receiver 112 may interact with other users in a network accordingly.

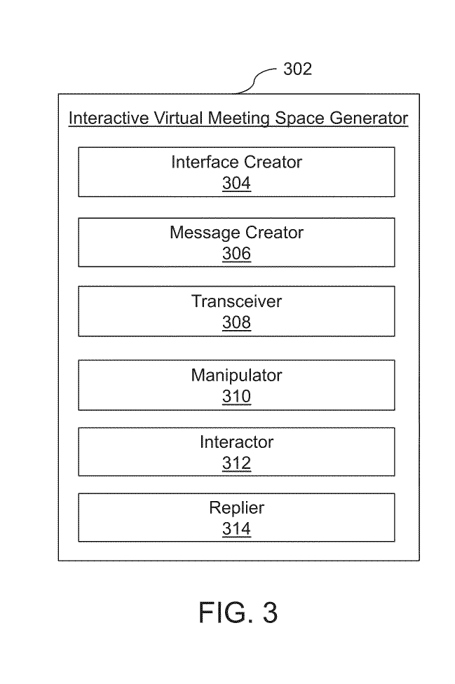

FIG. 3 illustrates block diagram of an interactive virtual meeting space generator 302 in network 114, in accordance with an embodiment of the invention. Interactive virtual meeting space generator 302 may be present anywhere in network 114 or at any device such as, but not limited to, first device 104, receiving device 110, one or more devices 106a-n, a server, and so forth. In an embodiment of the invention, interactive virtual meeting space generator 302 may be part of a service provider's network. In another embodiment of the invention, the interactive virtual meeting space generator 302 may be present in a cloud based network. Interactive virtual meeting space generator 302 may include an interface creator 304, a message creator 306, a transceiver 308, a manipulator 310, an interactor 312, and a replier 314. Interface creator 304 is configured to enable users such as first user 102 to create the virtual meeting space such as an online electronic greeting card. The electronic greeting card may include at least one interactive object. Moreover, the electronic greeting card is an interactive virtual meeting space. Message creator 306 is configured to enable creation of one or more messages for sharing the electronic greeting card. The virtual meeting space can be shared with other users such as one or more of a plurality of users such as one or more collaborators 108a-n, receiver 112, and so forth in network 114 by sending an electronic greeting card. In an embodiment of the invention, first user 102 may create a message to send the electronic greeting card and share the virtual meeting space with receiver 112 and/or collaborators 108a-n. Further, transceiver 308 is configured to enable sharing of the electronic greeting card. Furthermore, transceiver 308 is configured to enable users such as first user 102 to send the one or more messages to one or more collaborators 108a-n and/or receiver 112. Furthermore, transceiver 308 is configured to receive modified electronic greeting card including one or more changes from one or more collaborators 108a-n. Transceiver 308 may also receive reply from receiver 112.

Manipulator 310 is configured to enable manipulation of the at least one interactive object by the receiver i.e. receiver 112. Receiver 112 can also interact with the virtual meeting space by adding one or more interactive object into the electronic greeting card. Interactor 312 is configured to enable interaction of receiver 112 with first user 102 and/or one or more collaborators 108a-n, based on the manipulation of receiver 112 with the at least one interactive object. Replier 314 is configured to enable receiver 112 to reply by manipulating the at least one interactive object. The reply by receiver 112 may include an image, a text message, a social networking website status message, a social networking website mail, a social networking website profile page, a Short Messaging Service (SMS) message, a Multimedia Messaging Service (MMS) message, an instant message, an audio file, a video file, and combination of these.

In accordance with another embodiment of the invention, the interactive electronic greeting card may remain interactive only till a predefined condition is fulfilled. The predefined condition may be based on time, goal, purpose of an event and so forth. In an embodiment of the invention, the predefined condition may be set by first user 102 or one or more collaborators 108a-n. In another embodiment of the invention, the predefined condition may depend on an occurrence of an event such as but not limited to, a festival, a date, and so forth. In another embodiment of the invention, the Examples of the predefined condition include, but not limited to, 48 hours, 5 days, 3 months, Christmas, Good Friday, Thanks giving day, and so forth. In an embodiment of the invention, the electronic greeting card cannot be changed after the predefined condition is over. For example, an electronic greeting card or page created for Christmas can be collaborated or changed till Christmas Day only. After the Christmas is over the greeting page/card may be accessible, but only for viewing and cannot be changed or modified by any user (i.e. receiver 112 or first user 102 or one or more collaborators 108a-n). In an embodiment of the invention, the virtual meeting space or the electronic greeting card may remain active based on a predefined goal. For example, the virtual meeting space may be a greeting card for the purpose of gathering 1000 signatures to petition for a certain cause, or for the purpose of raising $1,000 of donation, or for a family to chip in money to buy an expensive gift for family members.

Further, the plurality of users can apply one or more play control functions to the electronic greeting card even after the predefined condition has been fulfilled. For example, a user can replay the interactions made in the past, the user can fast forward or rewind the interactions, the user may record the interactions on a DVD, CD etc to view on another device such as Television etc. Further, the user may print the electronic greeting card. In an embodiment of the invention, the plurality of users may select a printing theme such as a comic, a book, etc. for printing the electronic greeting card.

In an embodiment of the invention, when the electronic greeting card reaches the end of a life span, it becomes a time capsule. After end of life span of the electronic greeting card, the first users or participants may not be able to post new comment or add new content in the electronic greeting card. But the electronic greeting card can be accessed or viewed at a later time even after end of the life span of the social space. Therefore, even after the end of life span of the electronic greeting card, the participants or the first users are allowed to access or view the electronic greeting card by browsing objects that has been shared.

As shown in FIG. 4 the electronic greeting card may go through various stages in its life cycle. The stages may include for example, creation, sharing, sending and interaction with the electronic greeting card. In an exemplary scenario, a user such as first user 102 may desire to create and send the electronic greeting card to receiver such as receiver 112. For the sake of better understanding, the description and figures explains the concept assuming that receiver 112 is a grandmother of first user 102. However, a person skilled in the art will appreciate that first user 102 can send the card to anyone.

First user 102 may be reminded of an event such as a birthday, an anniversary, Christmas etc. For example, as shown in FIG. 4, first user 102 may be reminded by a social calendar 402 that may send an alert to first user 102 for a particular date. The alert may be in form of an e-mail or a message on a social networking web site such as Facebook, Orkut, Twitter, LinkedIn, and so forth. In an embodiment of the invention, first user 102 may remember the dates and occasions on which first user 102 would like to create and share virtual meeting space and may not be reminded by social calendar 402. For example, user 112 gets an alert for birthday of his/her grandmother. Thereafter, first user 102 may decide to send a greeting card in form of a virtual meeting space to the grandmother (or receiver 112). In an embodiment of the invention, the greeting card may be free of cost or the first user may be required to purchase the greeting card or pay for subscription to send the card. Further, the greeting card is created online in network 114 such as the Internet. Further, first user 102 may be required to visit a website on a web browser for creating the virtual meeting space such as the greeting card. The virtual meeting space or the greeting card may include at least one interactive object.

After the creation of the electronic greeting card, first user 102 may also sends the electronic greeting card to invite one or more of a plurality of users i.e. collaborators 108a-n to share and enhance the electronic greeting card. For example, collaborators 108a-n (hereafter referred to as friends) may be the friends, family members, relatives or others wanting to wish the grandmother (or receiver 112). For example, the friends may sign the greeting card and/or add images, graphics, videos, music, audio or other content to the greeting card (or the electronic greeting card).

By virtue of signing and decorating a card, the first users (i.e. first user 102, collaborators 108a-n) may also define what kind of content he/she wants to share with receiver 112. In an embodiment of the invention, the content (the at least one interactive object) may be one-time content e.g. a message or photo for a user to place in the electronic greeting card. In another embodiment of the invention, the content may be an ongoing stream of contents such as social networking website messages, Really Simple Syndication (RSS) feeds, and so forth which can be automatically shared into the electronic greeting card. For example, a user can choose to share his/her Facebook and Twitter updates, and these updates will automatically stream into the electronic greeting card.

One or more collaborators 108a-n or friends then sends back the card or message including electronic greeting card information to first user 102. Thereafter, first user 102 may share the virtual meeting space or the greeting card in a message or mail such as a message 404 with the grandmother. Thereafter, the grandmother may manipulate the at least one interactive object or interact with the greeting card or the electronic greeting card accordingly. For example, the grandmother may play a personal video recorded by the first user or the friends, or talk to the first user/friends and so forth. The greeting card thus becomes a virtual meeting space, where the grandmother (or receiver 112) can interact with first user 102 or friends.

In an embodiment of the invention, the first users (i.e. first user 102, receiver 112, one or more collaborators 108a-n) may record the electronic greeting card to create an electronic file such as a movie file and/or to generate a playback media such as a Blue-Ray, DVD file, to allow users to play back the social interactions on TV other playback devices. The generated file or media may support sequential or interactive playback. The interactive playback may allow the first users to interact with the content using simple controls such as TV remote.

The electronic greeting card is further explained in conjunction with FIG. 8. A person skilled in the art will appreciate that first user 102, grandmother and friends may use the devices to create, share and interact with the electronic greeting card.

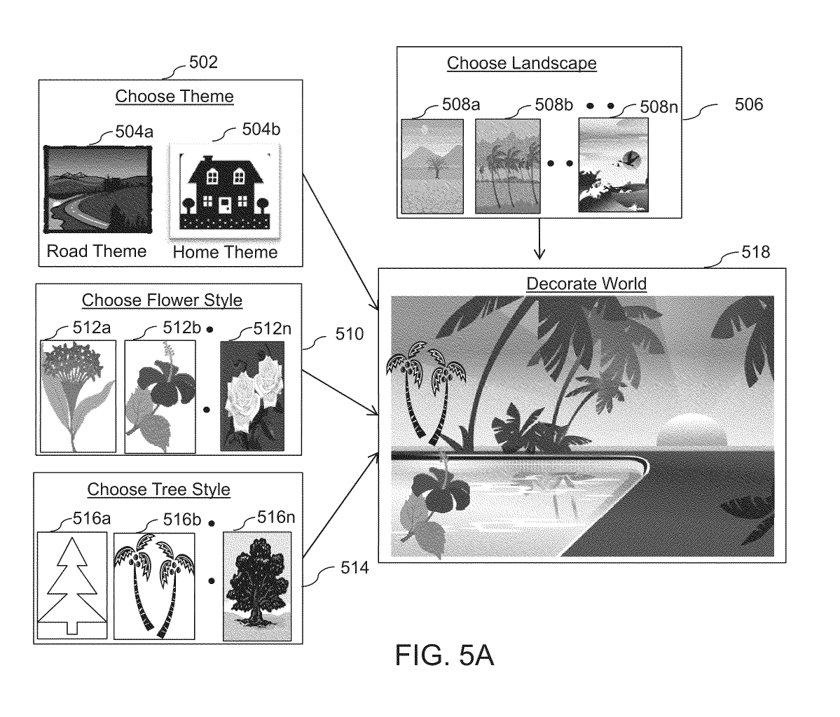

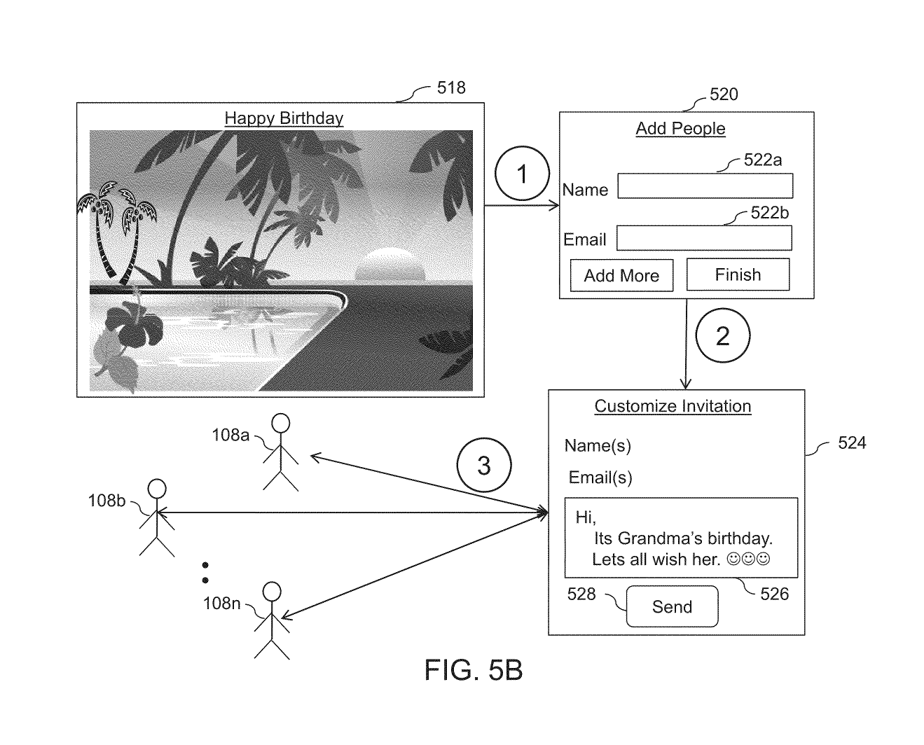

With reference to FIG. 5A, an exemplary process for creating the electronic greeting card is illustrated. As shown, first user 102 may create a virtual meeting space such as a greeting card at first device 104. In an embodiment of the invention, first user 102 may decorate an electronic greeting card 518 by using various elements. For example, as shown first user 102 may choose a theme such as ‘a forest theme’, a ‘home theme’, a ‘beach theme’ and so forth from an interface such as a ‘Choose Theme interface 502’. Further, first user 102 may select various elements to be displayed such as a fountain, a waterfall, flowers, cars, furniture and so forth from other interfaces such as, but not limited to, ‘Choose Landscape interface 506’, ‘Choose Flower Style interface 510’, ‘Choose Tree Style interface 514’, and so forth. Also, the characteristics of the various elements can be defined or selected. For example, the style and type of a flower, tree, furniture and so forth. Moreover, the colors or landscape for the space may be defined or selected. A person skilled in the art will appreciate that the elements thus discussed are exemplary and various other elements may be provided, defined and selected for electronic greeting card 502 or the greeting card.

FIG. 5B illustrates exemplary process for sharing the electronic greeting card for collaboration. After first user 102 has created electronic greeting card 518, one or more collaborators 108a-n (hereinafter, friends or family) may be invited to share and enhance electronic greeting card 518. First user 102 may invite the friends by sending them a message or an e-mail. For example, first user 102 may interact with an element such as a flower in electronic greeting card 518 to invite the friends. Further first user 102 may add one or more collaborators 108a-n or people to an invitation message. The invitation message is a message for inviting other users such as collaborators 108a-n to add content to electronic greeting card 518. First user 102 may add or invite collaborators 108a-n by creating a message such as an invitation message by using an interface 520. Interface 520 may include plurality of fields such as a name field 522a, an e-mail field 522b, and so forth. First user 102 may enter name of collaborators in name field 522a and may enter e-mails in e-mail field 522b.

First user 102 may create one or more messages such as a message to share electronic greeting card 518. Moreover, first user 102 may customize the message that is to be sent to the friends. First user 102 may use an interface 524 for customizing the message. Interface 524 may include fields such as field 526 for entering a customized message. Further, first user 102 may send the message to invite other collaborators 108a-n by selecting or clicking a tab such as send reply 528. A person skilled in art will appreciate that interface 520 and interface 524 may include other different fields and tabs also. By allowing signing and decorating a card, the first users (i.e. first user 102, collaborators 108a-n) may also define what kind of content he/she wants to share with receiver 112. In an embodiment of the invention, the content (the at least one interactive object) may be one-time content e.g. a message or photo for a user to place in the electronic greeting card. In another embodiment of the invention, the content may be an ongoing stream of contents such as social networking website messages, Really Simple Syndication (RSS) feeds, and so forth which can be automatically shared into electronic greeting card 802. For example, a user can choose to share his/her Facebook and Twitter updates, and these updates will automatically stream into the electronic greeting card.

The friends may then receive the message or the e-mail including electronic greeting card information and may collaborate on the electronic greeting card. After the friends have collaborated, first user 102 may be notified of their contributions by message or e-mail. The message or e-mail will include information for sharing the changed electronic greeting card with first user 102. In an embodiment of the invention, one or more collaborators 108a-n (or friends) may not collaborate to the electronic greeting card. Thereafter, first user 102 may send the greeting card or the virtual meeting space to the grandmother (or receiver 112).

In an embodiment of the invention, the interactive electronic greeting card may remain interactive only till a predefined condition is fulfilled. The predefined condition may be based on time, goal, purpose, etc. In an embodiment of the invention, the predefined condition may be set by first user 102 or one or more collaborators 108a-n. In another embodiment of the invention, the predefined condition may depend on an occurrence of an event such as but not limited to, a festival, a date, and so forth. Examples of the predefined condition include, but not limited to, 48 hours, 5 days, 3 months, Christmas, Good Friday, Independence Day, Father's Day, Mother's Day, Valentine's Day, Thanks giving day, and so forth. In an embodiment of the invention, the electronic greeting card cannot be changed after the predefined condition is fulfilled. For example, a virtual meeting space such as an electronic or online greeting card created for Independence Day can be collaborated or changed till Independence Day only. After the Independence Day is over the greeting card may be accessible, but only for viewing and cannot be changed or modified by any user (i.e. receiver 112 or first user 102 or one or more collaborators 108a-n).

In an embodiment of the invention, the system for generating, sharing and interacting electronic greeting card 802 may provide an echo map function to allow the first user(s) to define the best way to receive updates and new contents from the electronic greeting card 802. For example, busy moms might be running around with no access to computer during the day, and therefore not be able to view the online or electronic greeting card during the day. But she can choose to have the system “echoes” updates to her preferred channels, such as E-mail, SMS, Facebook, Twitter, etc. In another embodiment of the invention, the first user such as receiver 112 can define the kind of updates he/she wants to be echoed, and the type of echo destination technology (e.g. e-mail, SMS, etc.).

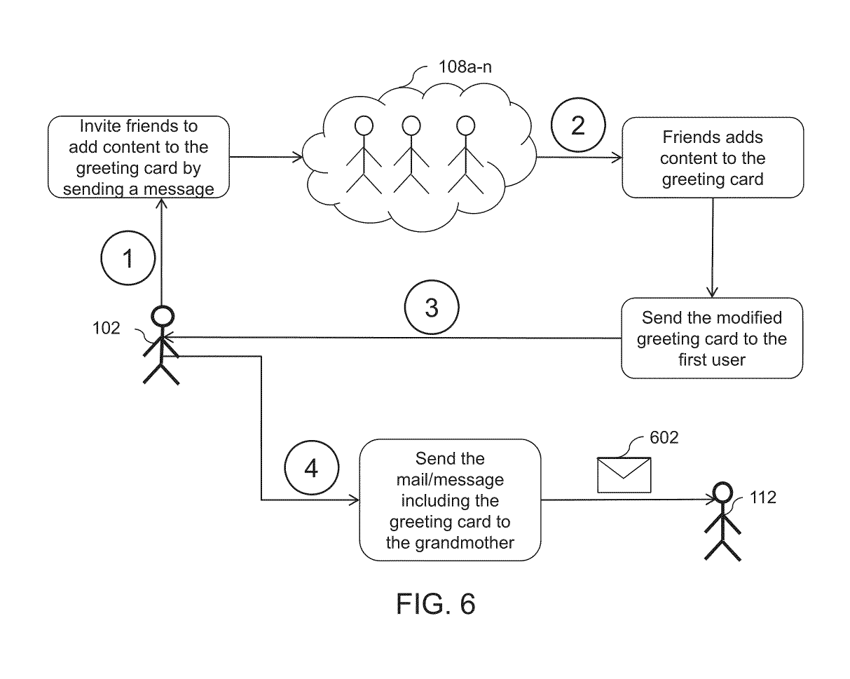

FIG. 6 illustrates exemplary process for collaborating on an electronic or online greeting card via a virtual meeting space. In an exemplary scenario, first user 102 may create and share a greeting card with one or more collaborators 108a-n. The friends (or collaborators 108a-n) may receive a message or an e-mail from the first user as shown. The message/e-mail may include a URL or link (such as hyperlink) for collaborating on the electronic greeting card. Thereafter, the friends may be displayed a webpage for collaborating. In an embodiment of the invention, the friends may be asked to provide their details on the webpage prior to making any changes or accessing the electronic greeting card. For example, the name, e-mail ID, social networking IDs, photos, and so forth. In an embodiment of the invention, each of collaborators 108a-n (i.e. friends) may have a personalized profile page including one or more details about collaborators 108a-n. In an embodiment of the invention, these personalized profile pages may be stored at a server in network 114. Thereafter, the friends may be displayed the electronic greeting card and may interact with other friends or the first user through the electronic greeting card. For example, the friends may send messages, chat or talk through the electronic greeting card. Moreover, the friends may add content to the electronic greeting card. The content may be selected from the provided content or customized or created by the friends on the electronic greeting card.

Thereafter, one or more collaborators 108a-n may share the electronic greeting card including one or more changes with first user 102. The one or more changes may be addition or deletion of one or more objects in the electronic greeting card. Collaborators 108a-n may share the electronic greeting card by sending a notification in form of a message/e-mail 602 to first user 102 on completion of the collaboration. In an embodiment of the invention, one or more collaborators 108a-n may also interact with first user 102 while making changes or collaborating on the greeting card (i.e. the virtual meeting space) First user 102 may then send the electronic greeting card as an electronic greeting card via a notification message or mail to the grandmother i.e. receiver 112. Subsequently, the grandmother may interact with the virtual meeting space/first user 102/friends. In an embodiment of the invention, message 602 may include a URL to electronic greeting card and/or a customized message. The grandmother may also reply to first user 102 or friends by manipulating at least one interactive object of the electronic greeting card.

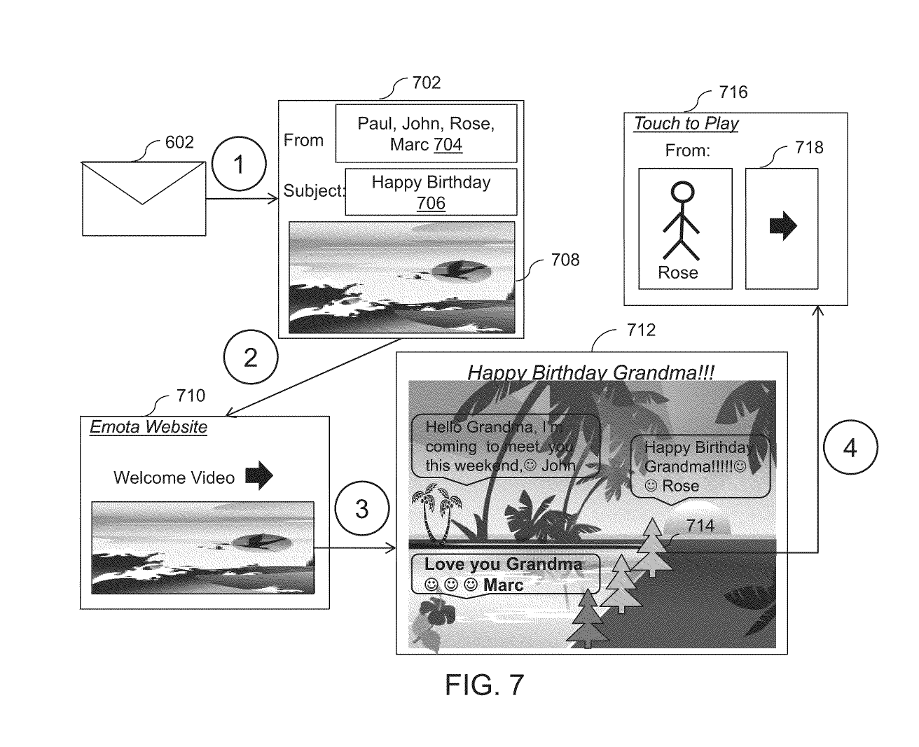

FIG. 7 illustrates an exemplary process for receiving an electronic greeting card by receiver 112 at receiving device 110. As discussed with reference to FIG. 6 receiver 112 such as a grandmother may receive a message/e-mail 602 including electronic greeting card from first user 102 for viewing and interacting with electronic greeting card. When receiver 112 opens message 602, a webpage 702 may be displayed. Webpage 702 may include a ‘From’ field 704 and a ‘Subject’ field 706. From field 704 may indicate the sender(s) of the message/e-mail 602. Subject field 706 may indicate purpose of the mail/e-mail 602. Webpage 702 may also include an image or URL 708 associated with the electronic greeting card. Receiver 112 may selects image or URL 708 to visit electronic greeting card. Therefore, when the grandmother clicks the link, a webpage may be displayed with a welcome screen 710. Welcome screen 70 may include a video, music, text, pictures, message, and so forth. Subsequently, electronic greeting card 712 is displayed to the grandmother or receiver 112. The grandmother may then interact with electronic greeting card 712 by selecting at least one interactive object such as an interactive object 714. For example, the grandmother can play the audio/video, view/zoom graphics/picture and so forth by selecting interactive object 714. The interactive object 714 can be, but not limited to, an image, an audio, a message, an SMS, and so forth. A web page 716 including touch-to-play option 718 may be displayed when user clicks on the at least one interactive object such as interactive object 714. The grandmother may listen or view message by selecting touch-to-play option 718 from the webpage 716.

FIG. 8 illustrates an exemplary electronic greeting card 802 as displayed to receiver 112 and/or one or more collaborators 108a-n. As shown, the grandmother/the first user/the friends may interact with electronic greeting card 802 by clicking/touching or sending gestures. Further, electronic greeting card 802 may be updated to display notifications of new messages, audios, videos, graphics, pictures, and so forth. Moreover, electronic greeting card 802 may be used to send new messages, audios, videos, graphics, pictures, and so forth. Furthermore, new elements/content may be added to electronic greeting card 802.

As a result, electronic greeting card 802 is persistent in that it persists after the initial sending, receiving and opening of electronic greeting card 802. Once the initial send/receive experience is over, the invention allows the first users and the receivers to continuously use this electronic greeting card 802 to communicate with each other in various ways. For example, first user 102, receiver 112 or collaborators 108a-n may convey presence information to each other (such as availability, location, what am I doing), may send to each other emotional gestures, greetings, text/audio/video messages, reminders, etc. Further, the people in electronic greeting card 802 can also make audio/video phone calls to each other using electronic greeting card 802.

Moreover, electronic greeting card 802 also provides user analytic functions to help users (i.e. first user 102/ receiver 112/ collaborators 108a-n) of electronic greeting card 802 be more aware of various conditions of other users. For example, if one user of electronic greeting card 802 is much less active than normal, or have not received any greetings for a while, the system can use this analytic information to alert or nudge other users into caring action, such as sending this person more greetings, gestures, messages, or even initiate a audio/video call. In an embodiment of the invention, receiver 112 may send a reply to first user 102 or one or more collaborators 108a-n by selecting a send button 804.

In an embodiment of the invention, electronic greeting card 802 may include a time machine play back mode. The time machine play back mode may allow the first users (such as first user 102, collaborators 108a-n, receiver 112) to replay or view the social interactions made in the past during or after the life span of the electronic greeting card 802. Further, the first users can relive the social interactions by playing back the interactions with fast forward options. An aspect of the invention allows the first user such as receiver 112 to access or view electronic greeting card 802 even after the end of the lifespan of electronic greeting card 802, and the social interactions will be replayed. According to another embodiment of the invention, the electronic greeting card may include an interface having multiple controls to allow the first users to replay the interactions in VCR mode, allowing fast forward, pause, replay, etc.

In an embodiment of the invention, the first users may record electronic greeting card 802 to create an electronic file such as a movie file and/or to generate a playback media such as a Blue-Ray, DVD file, to allow users to play back the social interactions on TV or other playback devices. The generated file or media may support sequential or interactive playback. The interactive playback may allow the first users to interact with the content i.e. one or more interactive objects by using simple controls such as TV remote.

In an embodiment of the invention, first user 102 may invite a plurality of collaborators 108a-n for creating, signing, and decorating electronic greeting card 802 such as an online or electronic greeting card, before sending it to one or more recipient 112. By virtue of signing and decorating a card, the first users (i.e. first user 102, collaborators 108a-n) may also define what kind of content he/she wants to share with receiver 112. In an embodiment of the invention, the content (the at least one interactive object) may be one-time content e.g. a message or photo for a user to place in electronic greeting card 802. In another embodiment of the invention, the content may be an ongoing stream of contents such as social networking website messages, Really Simple Syndication (RSS) feeds, and so forth which can be automatically shared into electronic greeting card 802. For example, a user can choose to share his/her Facebook and Twitter updates, and these updates will automatically stream into electronic greeting card 802.

An advantage of the invention present invention is that for setting up an electronic greeting card 802, the tasks of adding content, and setting up social update streams are distributed among multiple users i.e. first user 102, one or more collaborators 108a-n etc. Therefore, not one single individual need to bear the burden of setting up the entire persistent electronic greeting card 802.

Another aspect of the invention, receiver 112 doesn't require any prior setup. Once receiver 112 opens the card, he/she is automatically configured in electronic greeting card 802, and can view all the shared content and content streams from the first users (first user 102, collaborators 108a-n). In an embodiment of the invention, receiver 112 can interact with each of first user 102 or collaborators 108a-n. In other words, there is no need for receiver 112 to setup things such as address book, and go through any kind of “Find Friends” or other “friend searching” process.

In an embodiment of the invention, electronic greeting card 802 may allow the first users i.e. first user 102, one or more collaborators 108a-n, receiver 112, and so forth to include or consolidate all kinds of social networking and communication technologies into a single social environment or space. Therefore, electronic greeting card 802 may act as a two-way communication gateway between various social networking and communication technologies. The first users can choose any number of technologies as their primary methods of posting and receiving information with the group. Examples of the technologies include, but are not limited to, Short Message Service (SMS), Multimedia Message service (MMS), Electronic mail (E-mail), Facebook, Twitter, etc. This means a user can use a technology that he/she is already familiar with to communicate with the rest of the group. For example, a user can post a photo as a Facebook status updates, and if he chooses, this photo will automatically become an interactive object shared in electronic greeting card 802 which can be read and interacted with by other participants. Another user can share content using SMS.

In an embodiment of the invention, virtual meeting space 802 or online/electronic greeting card provides a simple, graphical interface, for people to interact with families and friends who are using any of the supported technologies. In other words, the grandmother does not have to learn how to use Facebook, Twitter, etc. and still be able to interact with grandkids that are using those technologies and have shared electronic greeting card 802 with her.

In an embodiment of the invention, the system for generating, sharing and interacting electronic greeting card 802 may provide an echo map function to allow the first user(s) to define the best way to receive updates and new contents from the electronic greeting card 802. For example, busy moms might be running around with no access to computer during the day, and therefore not be able to view the online or electronic greeting card during the day. But she can choose to have the system “echoes” updates to her preferred channels, such as E-mail, SMS, Facebook, Twitter, etc. In another embodiment of the invention, the first user such as receiver 112 can define the kind of updates he/she wants to be echoed, and the type of echo destination technology (e.g. e-mail, SMS, etc.).

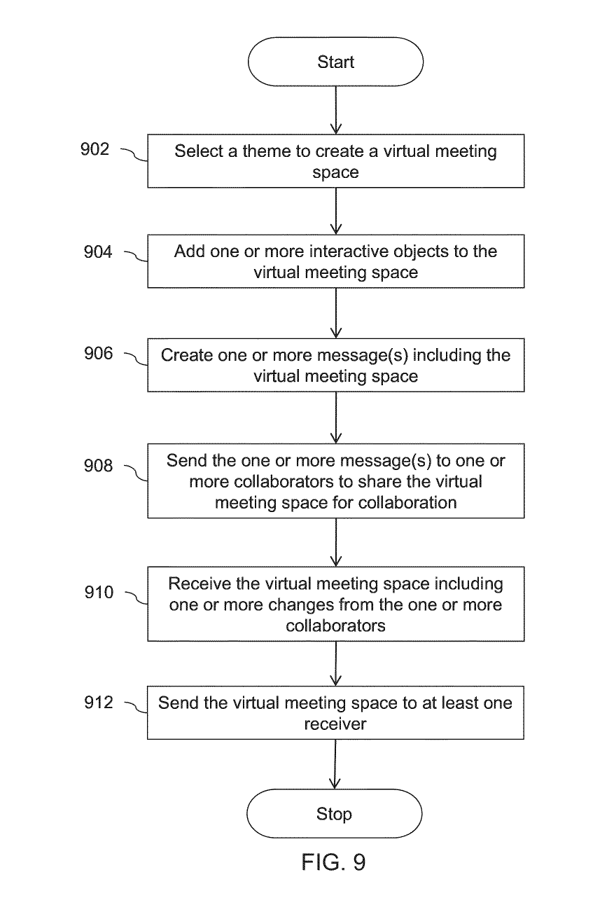

FIG. 9 illustrates an exemplary flowchart for creating an interactive electronic greeting card. As discussed with reference to FIG. 1 and FIG. 2, first user 102 can create or generate an electronic greeting card by using a first device 104. The electronic greeting card includes at least one interactive object. Further, the electronic greeting card provides a virtual meeting space for a plurality of users to interact. Examples of the at least one interactive object include, but are not limited to, an image, a text message, a social networking website status message, a social networking website mail, a social networking website profile page, a Short Messaging Service (SMS) message, a Multimedia Messaging Service (MMS) message, an instant message, an audio file, a video file, and so forth. In an embodiment of the invention, the electronic greeting card may be in form of an electronic greeting card that includes messages, graphics, audios, videos and/or various other options/modes for interaction. In an embodiment of the invention, first user 102 may create the electronic greeting card by using an interactive virtual meeting space generator 302 as disclosed in FIG. 3. In another embodiment of the invention, first user 102 may create an electronic greeting card by using one or more services provided by a service provider.

Further, first user 102 can also share the virtual meeting space with other users such as one or more collaborators 108a-n or receiver 112. First device 104 is configured to enable first user 102 to create one or messages to share the virtual meeting space with other users such as receiver 112 or one or more collaborators 108a-n. In an embodiment of the invention, first user 102 may share the virtual meeting space by sending an electronic greeting card. In another embodiment of the invention, first user 102 can create customized message including the electronic greeting card or information about the electronic greeting card for sharing the virtual meeting space. Further, first device 104 is configured to send the customized message to one or more collaborators 108a-n for collaboration. One or more collaborators or friends can make the changes in the electronic greeting card and send back to first user 102.

At step 902, a user may select a theme to create an electronic greeting card. In an embodiment of the invention, first user 102 may open or go to a website for creating electronic greeting card and select the theme from one or more themes present on the website. In an embodiment of the invention, first user 102 may be asked to pay prior to creating electronic greeting card at a server. For example, the theme can be, but not limited to, a home theme including images and background related to home, a jungle theme will include background and images related to jungle trees, a garden theme, a city theme, an office theme, a horror theme, and so forth. In an embodiment of the invention, the virtual meeting space is a greeting card or page (online or electronic greeting card). The electronic greeting card may provide a visual summary of the theme and content of the electronic greeting card. It may also be represented as a thumbnail image which can contain static or live updates of content and activities that are happening within the social space.

At step 904, first user 102 may add at least one interactive object to the electronic greeting card. Interactive object can be such as, but not limited to, an image, a music, an audio, a video, an SMS, social networking website status message, and so forth. In an embodiment of the invention, first user 102 may add the interactive objects by selecting from one or more interfaces as described in FIG. 5A. For example, first user 102 may add different types of trees, flowers, SMS message in the selected theme. First user 102 may select theme or add interactive objects for creating electronic greeting card by using a first interface creator 202. In an embodiment of the invention, electronic greeting card may be created by using interface creator 304 of interactive virtual meeting space generator 302.

At step 906, first user 102 may create one or more message(s) including the electronic greeting card or electronic greeting card information to share the virtual meeting space provided by the electronic greeting card. First user 102 may use first message creator 204 to create the message. Further, first user 102 may customize the message prior to sending it to one or more of the plurality of users or collaborators 108a-n. In an embodiment of the invention, first user 102 may create the message by using message creator 306 as described in FIG. 3. For example, once the first user feels that the electronic greeting card is complete (from his/her side), he/she may send the invitation to collaborators 108a-n. Subsequently, the system generates a message/e-mail with a Uniform Resource Locator (URL) or other information about the electronic greeting card to send to collaborators 108a-n.

At step 908, first user 102 may send the one or more message(s) to one or more of a plurality of users or one or more collaborators 108a-n to share the electronic greeting card for collaboration. In an embodiment of the invention, first transceiver 206 enables first user 102 to send the one or more message(s). In another embodiment of the invention, transceiver 308 may enable first user 102 to send the message(s). After receiving the message(s) at one or more devices 106a-n, collaborators 108a-n can add one or more interactive objects to the electronic greeting card.

At step 910, first user 102 may receive the electronic greeting card including one or more changes from the one or more of plurality of users. In an embodiment of the invention, the electronic greeting card may be received by first transceiver 206. In another embodiment of the invention, transceiver 308 enables first user 102 to receive the electronic greeting card at first device 104. Thereafter, at step 912, first user 102 may send or share the electronic greeting card to receiver such as receiver 112.

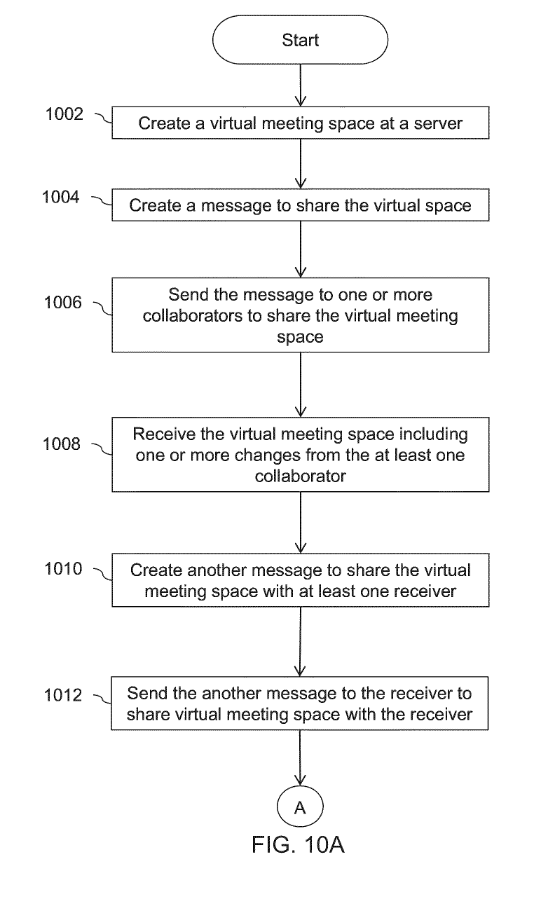

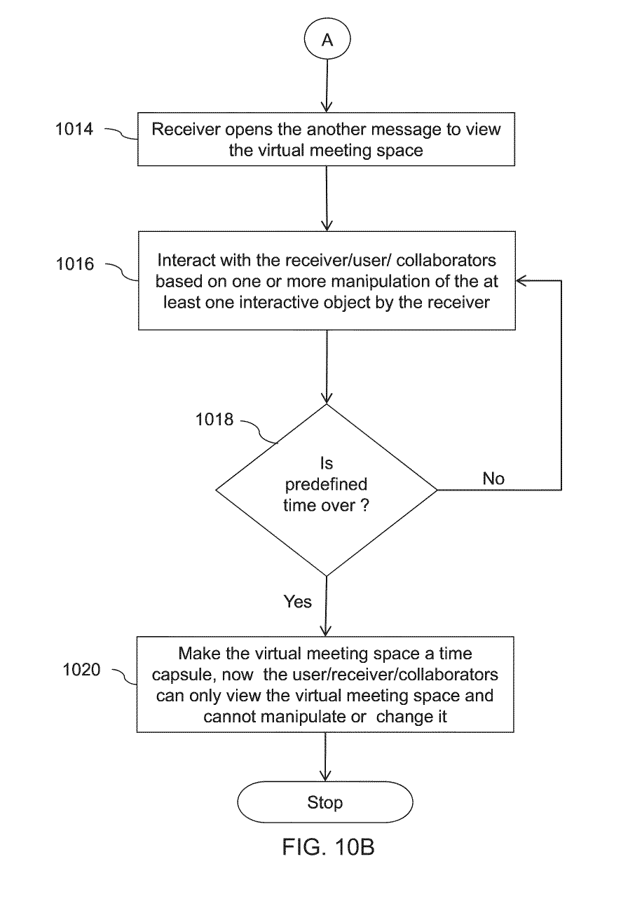

FIGS. 10A and 10B illustrates an exemplary flowchart for generating, sharing and interacting with an electronic greeting card, in accordance with an embodiment of the invention. As discussed with reference to FIG. 1, FIG. 2 and FIG. 9, first user 102 may create an electronic greeting card by using different interfaces at first device 104. Further, first user 102 may share the electronic greeting card with one or more collaborators 108a-n and receiver 112. In an embodiment of the invention, first user 102 may share an electronic greeting card by sending an electronic greeting card.

At step 1002, first user 102 may create an electronic greeting card including at least one interactive object. The electronic greeting card may be created by adding text, audio, video, graphics, and/or the elements/contents on a web page. For example, first user 102 may choose, create, “decorate” the electronic greeting card. Choosing a theme which essentially becomes the “scene” or “background/theme” of the electronic greeting card. Further, first user 102 may add details for example, name, e-mail address, SMS/Mobile phone number, avatar pictures, and login information for various social network applications that first user 102 wants to use to communicate presence and status information into the electronic greeting card. Moreover, first user 102 may include the information of receiver 112, for example, first user 102 may create an avatar for the receiver in the electronic greeting card. Furthermore, first user 102 may “decorate” electronic greeting card by using for example, various authoring tools or interfaces to customize the look and feel of the electronic greeting card, and customize the static and animated screen elements of the electronic greeting card. Moreover, first user 102 may record a personal greeting into the card for example, by entering a text or graphical message, and/or recording an audio or video greeting message.

Thereafter, first user 102 may create a message to share the electronic greeting card with one or more of plurality of users (such as friends, family or others people), at step 1004. For example, once the first user feels that the electronic greeting card is complete, he may send the invitation to the collaborators. Subsequently, the system generates a message/e-mail with a Uniform Resource Locator (URL) to send to collaborators 108a-n. At step 1006, first user 102 may send the message to one or more of a plurality of users to share the electronic greeting card. The one or more of the plurality of users may be one or more collaborators 108a-n. The one or more of the plurality of users may receive the link and interact with the electronic greeting card and/or add content/elements to the electronic greeting card. For example, collaborators 108a-n may add their videos, art or pictures in the electronic greeting card. The one or more of plurality of users may modify the electronic greeting card.

At step 1008, first user 102 may receive the modified electronic greeting card from one or more collaborators 108a-n. In an embodiment of the invention, first transceiver 206 may receive the modified electronic greeting card. In another embodiment of the invention, transceiver 308 may receive the electronic greeting card.

At step 1010, first user 102 may send create another message to share the modified electronic greeting card with receiver or receiver 112. The message(s) may be created by using first message creator 204. In an embodiment of the invention, first user 102 may create message (s) by using message creator 306 of interactive virtual meeting space generator 302. At step 1012, first user 102 may send the another message to receiver 112 to share electronic greeting card with receiver 112. For example, the electronic greeting card may be sent to grandmother. Subsequently, at step 1014, receiver 112 may open or view the another message to access view the electronic greeting card and enter into the virtual meeting space. Further, receiver 112 can manipulate the at least one interactive option such as message, music, image, and so forth of the virtual meeting space. For example, by clicking/touching or sending gestures.

At step 1016, receiver 112 may interact with first user 102 and plurality of user based on manipulations of the at least one interactive object by receiver 112. Further, the electronic greeting card may be updated to display notifications of new messages, audios, videos, graphics, pictures, and so forth. Moreover, the electronic greeting card may be used to send new messages, audios, videos, graphics, pictures, and so forth. Furthermore, new elements/content may be added to the electronic greeting card. Moreover, the electronic greeting card allows the members to echo their own presence and social network activities in the electronic greeting card. For example, the members may send messages into the electronic greeting card by using SMS, Instant Messengers, Twitter, etc. The members can also update each other of their status by allowing their social network status (for example, Facebook status updates) to be reflected in the electronic greeting card.

In an embodiment of the invention, the interactive virtual meeting space may remain interactive only till a predefined condition is fulfilled. In an embodiment of the invention, the predefined condition may depend on time, goal, purpose, and so forth. In an embodiment of the invention, the predefined condition may be set by first user 102 or one or more collaborators 108a-n. In another embodiment of the invention, the predefined condition may depend on an occurrence of an event such as, but not limited to, a festival, a date, and so forth. Examples of the predefined condition include, but not limited to, 48 hours, 5 days, 3 months, Christmas, Good Friday, Independence Day, Mother's Day, Valentine's Day, Thanks giving Day, and so forth. In another embodiment of the invention, the predefined condition may be based on a predefined goal e.g. a greeting card which will remain alive or interactive till 500 people have signed on this greeting card.

Further, the plurality of users can apply one or more play control functions such as, but not limited to, replay, play, rewind, fast-forward, pause, stop, record, print, and so forth to the electronic greeting card even after the predefined condition has been fulfilled. For example, a user of the plurality of users can replay the interactions made in the past, the user can fast forward or rewind the interactions. Further, the user may record the interactions on a DVD, CD etc to view through another device such as Television, DVD player, etc. Further, the user may print the electronic greeting card. In an embodiment of the invention, the plurality of users may select a printing theme such as a comic, a book, etc. for printing the electronic greeting card.

At step 1018, current time, day, and date is compared with a predefined condition to check whether predefined condition is fulfilled. If the predefined condition is fulfilled, then the virtual meeting space becomes a time capsule and then the first users i.e. first user 102, receiver 112, collaborators 108a-n are not allowed to change or add interactive objects to the electronic greeting card or the virtual meeting space. In an embodiment of the invention, the electronic greeting card cannot be changed after the predefined condition is fulfilled. Though it can be accessed or viewable even after the fulfillment of the predefined condition. For example, an electronic greeting card such as an online greeting page or card created for Christmas can be collaborated or changed till Christmas Day only. After the Christmas is over the greeting page/card may be accessible, but only for viewing and cannot be changed or modified by any user (i.e. receiver 112 or first user 102 or one or more collaborators 108a-n). If at step 1018, the predefined condition is not fulfilled, then the control goes back to step 1016 and the first users are allowed and can still interact or change interactive objects of the electronic greeting card.

In an embodiment of the invention, when the virtual meeting space or an online or electronic greeting card reaches the end of a life span, it becomes a time capsule. After end of life span of the virtual meeting space or the greeting card, the first users or participants may not be able to post new comment or add new content in the virtual meeting space. But the virtual meeting space can be accessed or viewed at a later time even after end of the life span of the electronic greeting card. Therefore, even after the end of life span of the electronic greeting card, the participants or the first users are allowed to access or view the electronic greeting card by browsing interactive objects that has been shared.

An advantage of the invention present invention is that for setting up an electronic greeting card, the tasks of adding content, and setting up social update streams in the electronic greeting card are distributed among multiple users i.e. first user 102, one or more collaborators 108a-n etc. Therefore, not one single individual need to bear the burden of setting up the entire persistent electronic greeting card.

Another aspect of the invention, receiver(s) doesn't require any prior setup. Once the receiver opens the card, he/she is automatically configured in the electronic greeting card, and can view all the shared content and content streams from the first users (first user 102, collaborators 108a-n). In an embodiment of the invention, the receiver can interact with user or collaborators. In other words, there is no need for the receiver to setup things such as address book, and go through any kind of “Find Friends” or other “friend searching” process. The disclosed system and method provides a user friendly platform to senior people to interact with their relatives, friends, etc. without going into many details about the computer and Internet etc.

In an embodiment of the invention, the electronic greeting card may allow the first users i.e. first user 102, one or more collaborators 108a-n, receiver 112, and so forth to include or consolidate all kinds of social networking and communication technologies into a single social environment or space. Therefore, the electronic greeting card may act as a two-way communication gateway between various social networking and communication technologies. The first users can choose any number of technologies as their primary methods of posting and receiving information with the group. Examples of the technologies include, but are not limited to, Short Message Service (SMS), Multimedia Message service (MMS), Electronic mail (E-mail), Facebook, Twitter, Orkut, etc. This means a user can use a technology that he/she is already familiar with to communicate with the rest of the group or other users. For example, a user can post a photo as a Facebook status updates, and if he chooses, this photo will automatically become an interactive object shared in the electronic greeting card which can be read and interacted with by other participants. Another user can share content using SMS.

In an embodiment of the invention, the virtual meeting space or online/electronic greeting card provides a simple, graphical interface, for people to interact with families and friends who are using any of the supported technologies. In other words, the grandmother does not have to learn how to use Facebook, Twitter, etc. and still be able to interact with grandkids that are using those technologies and have shared the virtual meeting space with her.

In an embodiment of the invention, the system for generating, sharing and interacting the electronic greeting card may provide an echo map function to allow the first user(s) to define the best way to receive updates and new contents from the electronic greeting card. For example, busy moms might be running around with no access to computer during the day, and therefore not be able to view the online or electronic greeting card during the day. But she can choose to have the system “echoes” updates to her preferred channels, such as E-mail, SMS, Facebook, Twitter, etc. In another embodiment of the invention, the first user such as receiver 112 can define the kind of updates he/she wants to be echoed, and the type of echo destination technology (e.g. e-mail, SMS, etc.).

Embodiments of the invention are also described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks.

These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

1. A computer-implemented method for interactive communication in a network, comprising:
creating, by a first user of a first device, an electronic greeting card comprising at least one interactive object, wherein the electronic greeting card provides a virtual meeting space for a plurality of users;
sending, by the first user, the electronic greeting card to one or more of the plurality of users, wherein the one or more of the plurality of users modify the electronic greeting card;
sending, by the first user, the modified electronic greeting card to a receiver; and
displaying, at a second device of the receiver, the modified electronic greeting card, wherein one or more of the plurality of the users, the receiver, and the first user can interactively communicate through the virtual meeting space provided by the modified electronic greeting card.

2. The method of claim 1, wherein the receiver interacts through the virtual meeting space by manipulating the at least one interactive object.

3. The method of claim 1, wherein sending the electronic greeting card to the plurality of users comprises:
creating a first message for the plurality of users; and
sending the customized message along with the electronic greeting card to the plurality of users for collaboration.

4. The method of claim 1 further comprising receiving the modified electronic greeting card from the one or more of the plurality of users.

5. The method of claim 1, wherein sending the electronic greeting card to the receiver further comprises:
creating a second message for the receiver; and
sending the second message to the receiver.

6. The method of claim 1, wherein the modified electronic greeting is displayed independent of a user account of the receiver on a website.

7. The method of claim 1, wherein the interactive communication in the virtual meeting space is performed through least one of an image, a text message, a social networking website status message, a social networking website mail, a social networking website profile page, a Short Messaging Service (SMS) message, a Multimedia Messaging Service (MMS) message, an instant message, an audio file, or a video file.

8. The method of claim 1, wherein the at least one interactive object comprises at least one of an image, a text message, a social networking website status message, a social networking website mail, a social networking website profile page, a Short Messaging Service (SMS) message, a Multimedia Messaging Service (MMS) message, an instant message, an audio file, or a video file.

9. The method of claim 1, wherein the interactive communication in the virtual meeting space is recorded for a later playback.

10. The method of claim 1, wherein the electronic greeting card is modifiable until a predefined condition.

11. A computer-implemented system for interactive communication in a network, comprising:
a first device associated with a first user, comprising:
a first interface creator configured to enable the first user to create an electronic greeting card comprising at least one interactive object, wherein the electronic greeting card provides a virtual meeting space for a plurality of users; and
a first transceiver configured to enable the first user:
to send the electronic greeting card to one or more of the plurality of users and a receiver, wherein the one or more of the plurality of users modify the electronic greeting card; and
to send the modified electronic greeting card to at least one receiver; and
a second device associated with the receiver, comprising:
a display configured to display the modified greeting card; and
a second interactor configured to enable the receiver to interactively communicate with the plurality of the users, the receiver, and the first user through the virtual meeting space.

12. The computer-implemented system of claim 11, wherein the second device further comprises a second manipulator configured to enable the receiver to manipulate the at least one interactive object.

13. The computer-implemented system of claim 11, wherein the first transceiver is further configured to receive the modified electronic greeting card from the one or more of the plurality of users.

14. The computer-implemented system of claim 11, wherein the first device further comprises a first message creator configured to enable the first user to create one or more first messages.

15. The computer-implemented system of claim 11, wherein the first transceiver is further configured to send the one or more messages to at least one of the one or more of the plurality of users and the receiver.

16. The computer-implemented system of claim 11 further comprising one or more devices associated with the one or more of the plurality of users, wherein each of the one or more devices comprises:
a third transceiver configured to receive the one or more messages comprising the electronic greeting card; and
an adder configured to enable the one or more of the plurality of users to add one or more interactive objects in the electronic greeting card.

17. The computer-implemented system of claim 11, wherein the second device further comprises:
a replier configured to enable the receiver to reply based on manipulation of the at least one interactive object, wherein the receiver is not required to do any setup comprising at least one of registering at a website, creating a user id, registering to a social space, creating a personal profile, adding friends, and setting up a meeting place at the second device; and
a second transceiver configured to receive the one or more messages from at least one of the first user and one or more plurality of users.
